(19) United States
(12) Patent Application Publication
(10) Pub. No.: US 2017/0327620 A1
(43) Pub. Date: Nov. 16, 2017

(54) METHOD FOR PRODUCING VISCOELASTIC POLYURETHANE FOAMS

(71) Applicant: Covestro Deutschland AG, Leverkusen (DE)

(72) Inventors: Matthäus Gossner, Köln (DE); Lutz Brassat, Leverkusen (DE); Dieter Seidel, Köln (DE)

(21) Appl. No.: 15/533,070

(22) PCT Filed: Dec. 8, 2015
(86) PCT No.: PCT/EP2015/079013

§ 371 Date: Jun. 5, 2017

(30) Foreign Application Priority Data
Dec. 10, 2014 (EP) 14197081.4

(51) Int. Cl. C08G 18/08; C08G 18/76; C08G 18/48; C08G 101/00; A47C 27/14; B68G 11/04; B60N 2/70; B60N 2/48; B60N 2/46; A47C 7/18

(52) U.S. Cl. CPC C08G 18/14; C08G 18/4812; C08G 18/7671; C08G 2101/005; C08G 2101/0008; A47C 27/14; A47C 7/18; C08G 2101/0083; B60N 2/70; B60N 2/48; B60N 2/46; C08G 2101/0058; B68G 11/04

(57) ABSTRACT

The present invention relates to a method for producing a viscoelastic polyurethane soft foam. The invention further relates to a viscoelastic polyurethane soft block foam or viscoelastic polyurethane soft molded foam having particularly high tensile strengths, which are produced by the method according to the invention, and to the use of said foams. The present invention further relates to polyol compositions which are suitable for the production of viscoelastic polyurethane foams.

### CROSS-REFERENCE TO RELATED APPLICATIONS

This Application is a National Phase Application of PCT/EP2015/079013, filed Dec. 8, 2015, which claims priority to European Application No. 14197081.4 filed Dec. 10, 2014, each of which is being incorporated herein by reference.

### FIELD

The present invention relates to a process for producing a viscoelastic flexible polyurethane foam. The invention further relates to a viscoelastic flexible slabstock polyurethane foam or viscoelastic flexible molded polyurethane foam having particularly high tensile strengths produced by the process according to the invention and to the use of these foams. The present invention further relates to polyol compositions suitable for the production of viscoelastic polyurethane foams.

### BACKGROUND

Viscoelastic foams, also known as memory foams, low-resilience foams or energy absorbing foams, are nowadays widely used for the production of mattresses, cushions and damping elements. Fields of application may be found in orthopedics, in motor vehicle manufacture, as packaging material, in sporting goods, toys and furniture.

Among the viscoelastic foam materials those made of polyurethanes are undoubtedly of greatest importance. This is because the physical properties of the polyurethane foam to be obtained can be adjusted very precisely through the choice of the employed polyol and isocyanate components and optionally further auxiliary substances and also because “in situ” production (optionally on-site) allows foam materials to be produced in virtually any desired, and very complex, shapes and structures.

Viscoelastic foams are notable for their slow, gradual recovery from compression. This manifests, for example, in a high hysteresis (>20%; in pressure-tension curves when determining the indentation hardness to DIN EN ISO 2439 or the compression hardness to DIN EN ISO 3386-1-98) or in a low ball rebound resilience (<15%; as determined to DIN EN ISO 8307).

WO-A 01/32736 discloses a polyether polyol composition for producing viscoelastic polyurethane foams comprising the following components:

b1) a polyoxyethylene-polyoxypropylene polyol having a functionality of 2 to 6, wherein the polymer chain is EO-tipped and/or has a random EO distribution and the total content of ethylene oxide is at least 50 wt %,

b2) a polyoxyethylene-polyoxypropylene polyol having a functionality of 2 to 6, wherein the polymer chain is EO-tipped and/or has a random EO distribution and the total content of ethylene oxide is between 20 and 50 wt % and the proportion of primary hydroxyl groups is at least 50% based on the total number of primary and secondary hydroxyl groups,

b3) a polyoxyethylene-polyoxypropylene polyol having a functionality of 2 to 6, wherein the EO content is between 10 and 20 wt % and the proportion of primary hydroxyl groups is at least 50% based on the total number of primary and secondary hydroxyl groups,

b4) a polyalkylene glycol having an average molecular weight of 100 to 120 g/mol;

the polyols b1, b2, b3 and b4 are present in the following amounts based on the total mass of all polyols b1, b2, b3 and b4: b1: 30-85 wt %, b2: 5-65 wt %, b3: 5-40 wt %, b4: 0-50 wt %.

EP-A 2 225 304-A1 discloses viscoelastic polyurethane foams having a tensile strength to DIN EN ISO 1798 of 30 to 60 kPa. The polyether polyol composition employed for production of these viscoelastic polyurethane foams comprises

a) a polyether polyol having a functionality of 2, an OH number in the range from 50 to 65 mg KOH/g and a proportion of primary OH groups in the range from 40% to 80% based on the total number of primary and secondary OH groups and having a PO content of 45 to 55 wt % and an EO content of 40 to 55 wt %,

b) a dispersion of a polymer in a polyether polyol, wherein the OH number of the dispersion is in a range from 10 to 30 mg KOH/g, and wherein the polyether polyol has a hydroxyl functionality of 3, a proportion of primary hydroxyl groups in a range from 70% to 90% based on the total number of primary and secondary hydroxyl groups, a PO content in an amount from 70 to 90 wt % and an EO content in an amount from 10 to 30 wt %;

c) a polyether polyol having a hydroxyl functionality of 3, an OH number in a range from 220 to 290 mg KOH/g and a proportion of primary hydroxyl groups in a range from at least 90% based on the total number of primary and secondary hydroxyl groups and having a PO content in an amount of up to 2 wt % and an EO content in an amount of at least 75 wt %;

d) a polyether polyol having a hydroxyl functionality of 2, an OH number in a range from 50 to 70 mg KOH/g and a proportion of primary hydroxyl groups in a range from 0 to 3% based on the total number of primary and secondary hydroxyl groups and having a PO content in an amount of at least 95 wt % and an EO content in an amount of up to 3 wt %.

Heretofore known viscoelastic polyurethane foams generally have tensile strengths determined to DIN EN ISO 1798 in the range from 30 to 90 kPa. Viscoelastic polyurethane foams having a markedly higher tensile strength with low temperature dependence of the viscoelastic character would be desirable. The components employed for producing these viscoelastic polyurethane foams should moreover be easy to process.

### SUMMARY

It is accordingly an object of the present invention to provide a simple process for producing viscoelastic flexible polyurethane forms having tensile strengths according to DIN EN ISO 1798 of ≧90 kPa, preferably ≧95 kPa, particularly preferably ≧100 kPa.

This object was achieved, surprisingly, by a process for producing viscoelastic flexible polyurethane foam obtainable by reaction of a polyol component A comprising
A1 at least one polyether polyol having a functionality of 2 to 6, preferably 2 to 4, having an OH number according to DIN 53240 of ≧20 to ≦80 mg KOH/g, preferably ≧25 to ≦50 mg KOH/g, particularly preferably of ≧30 to ≦40 mg KOH/g, wherein the ethylene oxide is present as an EO mixed block and a terminal block of pure ethylene oxide, wherein the total content of ethylene oxide is ≧50 wt %, preferably ≧60 wt %, particularly preferably ≧65 wt %, with a content of primary hydroxyl groups of ≧50 mol %, preferably of ≧60 mol %, particularly preferably ≧75 mol %,
A2 at least one polyether polyol having a functionality of 2 to 6, preferably of 2 to 4, having an OH number according to DIN 53240 of ≧180 to ≦320 mg KOH/g, preferably of ≧190 to ≦300 mg KOH/g, particularly preferably of ≧210 to ≦280 mg KOH/g, wherein the ethylene oxide is present as an EO mixed block, wherein the total content of ethylene oxide is 0 to 10 wt %, preferably from 0 to 5 wt %, particularly preferably 0 wt %,
A3 at least one polyether polyol having a functionality of 2 to 6, preferably of 2 to 4, having an OH number according to DIN 53240 of ≧15 to ≦40 mg KOH/g, preferably of ≧20 to ≦35 mg KOH/g, particularly preferably of ≧23 to ≦33 mg KOH/g, wherein the ethylene oxide is present as a terminal block of pure ethylene oxide and optionally as an EO mixed block, wherein the total content of ethylene oxide is 5 to 30 wt %, preferably 10 to 25 wt %, particularly preferably 10 to 20 wt %, with a content of primary hydroxyl groups of ≧50 mol %, preferably of ≧60 mol %, particularly preferably of ≧70 mol %,
A4 at least one polyether polyol having a functionality of ≧2.0 to ≦2.2, having an OH number according to DIN 53240 of ≧10 to ≦40 mg KOH/g, preferably of ≧15 to ≦35 mg KOH/g, particularly preferably of ≧20 to ≦30 mg KOH/g, wherein the ethylene oxide is present as a terminal block of pure ethylene oxide and optionally as an EO mixed block, wherein the total content of ethylene oxide is 5 to 30 wt %, preferably 10 to 25 wt %, particularly preferably from 10 to 20 wt %, with a content of primary hydroxyl groups of ≧50 mol %, preferably of ≧60 mol %, particularly preferably of ≧70 mol %,
A5 water and/or physical blowing agent,
A6 compounds comprising polyether polyols having an OH number according to DIN 53420 of 250 to 550 mg KOH/g, preferably 300 to 500 mg KOH/g, particularly preferably of 350 to 450 mg KOH/g.
A7 auxiliary and added substances such as
   a) catalysts,
   b) surface-active added substances,
   c) additives

with component B comprising di- and/or polyisocyanates

at an isocyanate index of 70 to 120, preferably of 80 to 100.

### DETAILED DESCRIPTION

In the process according to the invention the components may be reacted according to the following proportions, wherein the weight fractions of A1, A2, A3 and A4 sum to 100. A1: from 25 to 45 parts by wt, preferably from 28 to 40 parts by wt, particularly preferably from 32 to 38 parts by wt; A2: from 23 to 40 parts by wt, preferably from 25 to 38 parts by wt; particularly preferably from 28 to 34 parts by wt; A3: from 20 to 35 parts by wt, preferably from 23 to 33 parts by wt, particularly preferably from 27 to 31 parts by wt; A4: from 0 to 10 parts by wt, preferably from 0 to 8 parts by wt, particularly preferably from 0 to 6 parts by wt; A5: 0.5 to 25 parts by wt, preferably 0.8 to 15.0 parts by wt, particularly preferably 1.0 bis 5.0 parts by wt (based on the sum of the parts by wt of components A1, A2, A3 and A4); A6: from 0.1 to 10.0 parts by wt, preferably from 0.2 to 9.0 parts by wt, particularly preferably 3.0 to 7.0 parts by wt (based on the sum of the parts by wt of components A1, A2, A3 and A4); A7: 0.05 to 10.0 parts by wt, preferably 0.1 to 7.5 parts by wt, particularly preferably 0.15 to 7.0 parts by wt (based on the sum of the parts by wt of components A1, A2, A3 and A4).

The viscoelastic polyurethane foams obtainable by the process according to the invention have a tensile strength of ≧90 kPa, preferably ≧95 kPa, particularly preferably ≧100 kPa. These viscoelastic polyurethane foams moreover have an apparent density according to DIN EN ISO 845 of 40 to 70 kg/m³, preferably of 45 to 55 kg/m³.

The present invention further provides a polyol composition comprising
A1 at least one polyether polyol having a functionality of 2 to 6, preferably 2 to 4, having an OH number according to DIN 53240 of ≧20 to ≦80 mg KOH/g, preferably ≧25 to ≦50 mg KOH/g, particularly preferably of ≧30 to ≦40 mg KOH/g, wherein the ethylene oxide is present as an EO mixed block and a terminal block of pure ethylene oxide, wherein the total content of ethylene oxide is ≧50 wt %, preferably ≧60 wt %, particularly preferably ≧65 wt %, with a content of primary hydroxyl groups of ≧50 mol %, preferably of ≧60 mol %, particularly preferably ≧75 mol %,
A2 at least one polyether polyol having a functionality of 2 to 6, preferably of 2 to 4, having an OH number according to DIN 53240 of ≧180 to ≦320 mg KOH/g, preferably of ≧190 to ≦300 mg KOH/g, particularly preferably of ≧210 to ≦280 mg KOH/g, wherein the ethylene oxide is present as an EO mixed block, wherein the total content of ethylene oxide is 0 to 10 wt %, preferably from 0 to 5 wt %, particularly preferably 0 wt %,
A3 at least one polyether polyol having a functionality of 2 to 6, preferably of 2 to 4, having an OH number according to DIN 53240 of ≧15 to ≦40 mg KOH/g, preferably of ≧20 to ≦35 mg KOH/g, particularly preferably of ≧23 to ≦33 mg KOH/g, wherein the ethylene oxide is present as a terminal block of pure ethylene oxide and optionally as an EO mixed block, wherein the total content of ethylene oxide is 5 to 30 wt %, preferably 10 to 25 wt %, particularly preferably 10 to 20 wt %, with a content of primary hydroxyl groups of ≧50 mol %, preferably ≧60 mol %, particularly preferably ≧70 mol %,
A4 at least one polyether polyol having a functionality of ≧2.0 to ≦2.2 having an OH number according to DIN 53240 of ≧10 to ≦40 mg KOH/g, preferably of ≧15 to ≦35 mg KOH/g, particularly preferably of ≧20 to ≦30 mg KOH/g, wherein the ethylene oxide is present as a terminal block of pure ethylene oxide and optionally as an EO mixed block, wherein the total content of ethylene oxide is 5 to 30 wt %, preferably 10 to 25 wt %, particularly preferably from 10 to 20 wt %, with a content of primary hydroxyl groups of ≧50 mol %, preferably of ≧60 mol %, particularly preferably of ≧70 mol %,

The polyether polyols A1 to A4 may be present in the polyol composition in the following amounts: A1: from 25 to 45 wt %, preferably from 28 to 40 wt %, particularly preferably 32 to 38 wt %; A2: from 23 to 40 wt %, preferably from 25 to 38 wt %; particularly preferably from 28 to 34 wt %; A3: from 20 to 35 wt %, preferably from 23 to 33 wt %, particularly preferably from 27 to 31 wt %; A4: from 0 to 10 wt %, preferably from 0 to 8 wt %, particularly preferably from 0 to 6 wt %.

It has become customary according to the prior art to more precisely specify the polyether polyols of component A in terms of various characteristic parameters:
i.) the hydroxyl functionality which is dependent on the starter molecule from which the polyether polyol is synthesized;
ii.) the hydroxyl or OH number which is a measure of the content of hydroxyl groups and is reported in mg KOH/g. It is determined according to DIN 53240;
iii.) the molecular mass (M_{W}) which is a measure of the length of the polyoxy-alkylene chains of the polyether polyols.

The abovementioned parameters can be made to relate to each other via the following equation:

56 100=OH number·(M_{W}/hydroxyl functionality).

The production of the compounds according to A1 to A4 and A6 may be effected by catalytic addition of one or more alkaline oxides onto starter compounds having Zerewittinoff-active hydrogen atoms.

Starter compounds having Zerewittinoff-active hydrogen atoms and used for producing the polyether polyols have functionalities of 2 to 6, preferably 2 to 4, and are hydroxyl functional. Examples of hydroxyl-functional starter compounds are propylene glycol, ethylene glycol, diethylene glycol, dipropylene glycol, 1,2-butanediol, 1,3-butanediol, 1,4-butanediol, 1,6-hexanediol, 1,5-pentanediol, 3-methyl-1,5-pentanediol, 1,12-dodecanediol, glycerol, trimethylolpropane, triethan-olamine, pentaerythritol, sorbitol, sucrose, hydroquinone, catechol, resorcinol, bisphenol F, bisphenol A, 1,3,5-trihydroxybenzene, methylol-containing condensates of formaldehyde and phenol or melamine or urea. Mixtures of starter compounds may also be employed. Preferably employed starter compounds are glycerol, trimethylolpropane and/or sorbitol.

Suitable alkylene oxides are, for example, ethylene oxide, propylene oxide, 1,2-butylene oxide/2,3-butylene oxide and styrene oxide. It is preferable when propylene oxide and ethylene oxide are supplied to the reaction mixture individually, in admixture or successively. When the alkylene oxides are metered in successively the products produced comprise polyether chains having block structures. Products having ethylene oxide end blocks are characterized, for example, by elevated concentrations of primary end groups, which impart advantageous isocyanate reactivity to the systems.

### Component A1

Component A1 comprises at least one polyether polyol having a functionality of 2 to 6, preferably of 2 to 4, having an OH number according to DIN 53240 of ≧20 to ≦80 mg, preferably of ≧25 to ≦50 mg KOH/g, particularly preferably of ≧30 to ≦40 mg KOH/g, wherein the ethylene oxide is present as an EO mixed block and a terminal block of pure ethylene oxide, wherein the total content of ethylene oxide is ≧50 wt %, preferably ≧60 wt %, particularly preferably ≧65 wt %, with a content of primary hydroxyl groups of ≧50 mol %, preferably of ≧60 mol %, particularly preferably ≧75 mol %.

### Component A2

Component A2 comprises at least one polyether polyol having a functionality of 2 to 6, preferably of 2 to 4, having an OH number according to DIN 53240 of ≧180 to ≦320 mg KOH/g, preferably of ≧190 to ≦300 mg KOH/g, particularly preferably of ≧210 to ≦280 mg KOH/g, wherein the ethylene oxide is present as an EO mixed block, wherein the total content of ethylene oxide is 0 to 10 wt %, preferably from 0 to 5 wt %, particularly preferably 0 wt %.

### Component A3

Component A3 comprises at least one polyether polyol having a functionality of 2 to 6, preferably of 2 to 4, having an OH number according to DIN 53240 of ≧15 to ≦40 mg KOH/g, preferably of ≧20 to ≦35 mg KOH/g, particularly preferably of ≧23 to ≦33 mg KOH/g, wherein the ethylene oxide is present as a terminal block of pure ethylene oxide and optionally as an EO mixed block, wherein the total content of ethylene oxide is 5 to 30 wt %, preferably 10 to 25 wt %, particularly preferably 10 to 20 wt %, with a content of primary hydroxyl groups of ≧50 mol %, preferably of ≧60 mol %, particularly preferably of ≧70 mol %.

### Component A4

Component A4 comprises at least one polyether polyol having a functionality of ≧2.0 to ≦2.2 having an OH number according to DIN 53240 of ≧10 to ≦40 mg KOH/g, preferably of ≧15 to ≦35 mg KOH/g, particularly preferably of ≧20 to ≦30 mg KOH/g, wherein the ethylene oxide is present as a terminal block of pure ethylene oxide and optionally as an EO mixed block, wherein the total content of ethylene oxide is 5 to 30 wt %, preferably 10 to 25 wt %, particularly preferably from 10 to 20 wt %, with a content of primary hydroxyl groups of ≧50 mol %, preferably of ≧60 mol %, particularly preferably of ≧70 mol %.

The preferred ranges for the inventive components A1 to A4 may be combined with one another as desired.

### Component A5

Water and/or physical blowing agents are employed as component A5. Physical blowing agents employed as blowing agents are for example carbon dioxide and/or volatile organic substances. It is preferable when water is employed as component A5.

### Component A6

Component A6 comprises polyether polyols having an OH number according to DIN 53420 of 250 to 550 mg KOH/g, preferably of 300 to 500 mg KOH/g, particularly preferably of 350 to 450 mg KOH/g.

### Component A7

Employed as component A7 are auxiliary and added substances such as
a) catalysts (activators),
b) surface-active added substances (surfactants), such as emulsifiers and foam stabilizers, in particular those having low emissions, for example products of the Tegostab® LF series,
c) additives such as reaction retardants (for example slightly acidic substances, cell regulators (for example paraffins or fatty alcohols or dimethylpolysiloxanes), pigments, dyes, flame retardants (for example tricresyl phosphate, ammonium polyphosphate, melamine, trischloroisopropyl phosphate), stabilizers against aging and weathering effects, plasticizers, fungistatic and bacteriostatic substances, fillers (for example barium sulfate, kieselguhr, carbon black or whiting) and release agents.

These auxiliary and added substances for optional use are described for example in EP-A 0 000 389, pages 18-21. Further examples of auxiliary and added substances for optional use according to the invention and also details concerning ways these auxiliary and added substances are used and function are described in Kunststoff-Handbuch, volume VII, edited by G. Oertel, Carl-Hanser-Verlag, Munich, 3rd edition, 1993, for example on pages 104-127.

Preferred catalysts are aliphatic tertiary amines (for example trimethylamine, tetramethylbutanediamine), cycloaliphatic tertiary amines (for example 1,4-diaza[2.2.2]bicyclooctane, aliphatic amino ethers (for example dimethylaminoethyl ether and N,N,N-trimethyl-N-hydroxyethylbisaminoethyl ether), cycloaliphatic amino ethers (for example N-ethylmorpholine), aliphatic amidines, cycloaliphatic amidines, urea, derivatives of urea (for example aminoalkylureas; see, for example, EP-A 0 176 013, especially (3-dimethylaminopropylamino)urea), and tin catalysts (for example dibutyltin oxide, dibutyltin dilaurate, tin octoate).

Particularly preferred catalysts are
α) urea, derivatives of urea and/or
β) amines and aminoethers each comprising a functional group which undergo a chemical reaction with the isocyanate. The functional group is preferably a hydroxyl group, a primary or secondary amino group. These particularly preferred catalysts have the advantage that they exhibit strongly reduced migration and emission characteristics.

Examples of particularly preferred catalysts that may be mentioned are: (3-dimethylaminopropylamine)urea, 2-(2-dimethylaminoethoxy)ethanol, N,N-bis(3-dimethylaminopropyl)-N-isopropanolamine, N,N,N-trimethyl-N-hydroxyethylbisaminoethyl ether and 3-dimethylaminopropylamine.

### Component B

Component B comprises diisocyanates, polyisocyanates, mixtures of diisocyanates and/or polyisocyanates, mixtures of isomers thereof, carbodiimides, uretdioneimines or prepolymers.

Suitable di- and/or polyisocyanates, mixtures of diisocyanates and/or polyisocyanates, mixtures of isomers thereof, are aliphatic, cycloaliphatic, araliphatic, aromatic and heterocyclic polyisocyanates, as described, for example, by W. Siefken in Justus Liebigs Annalen der Chemie, 562, pages 75 to 136, for example those of formula (III)

Q(NCO)ₙ, (I)

in which

n=2-4, preferably 2-3,

and

Q is an aliphatic hydrocarbon radical having 2-18, preferably 6-10, carbon atoms, a cycloaliphatic hydrocarbon radical having 4-15, preferably 6-13, carbon atoms or an araliphatic hydrocarbon radical having 8-15, preferably 8-13, carbon atoms.

Polyisocyanates as described in EP-A 0 007 502, pages 7-8, are concerned, for example. Preference is generally given to the readily industrially available polyisocyanates, for example tolylene 2,4- and 2,6-diisocyanate and any desired mixtures of these isomers (“TDI”); polyphenyl polymethylene polyisocyanates as prepared by aniline-formaldehyde condensation and subsequent phosgenation (“crude MDI”), and polyisocyanates having carbodiimide groups, urethane groups, allophanate groups, isocyanurate groups, urea groups or biuret groups (“modified polyisocyanates”), especially those modified polyisocyanates which derive from tolylene 2,4- and/or 2,6-diisocyanate or from diphenylmethane 4,4′- and/or 2,4′-diisocyanate. Preferably employed polyisocyanates are one or more compounds selected from the group consisting of 2,4- and/or 2,6-tolylene diisocyanate, 4,4′-, 2,4′-, 2,2′-diphenylmethane diisocyanate, oligomeric diphenylmethane diisocyanate and polyphenylpolymethylene polyisocyanate (“polynuclear MDI”); particularly preferably employed polyisocyanates are mixtures of 4,4′-, 2,4′-, 2,2′-diphenylmethane diisocyanate, oligomeric diphenylmethane diisocyanate and/or polyphenylpolymethylene polyisocyanate (“polynuclear MDI”)

The NCO content of the employed isocyanate component B is in a range from 20 to 45 wt %, preferably from 28 to 40 wt %, particularly preferably from 30.5 to 34 wt %.

In a particularly preferred embodiment of the present invention a mixture of 4,4′-, 2,4′-, 2,2′-diphenylmethane diisocyanate, oligomeric diphenylmethanediisocyanate and/or polyphenylpolymethylene polyisocyanate (“polynuclear MDI”) having an NCO content of 30.5 to 34 wt % is employed as component B

To produce the viscoelastic flexible polyurethane foams, the reaction components are reacted by the one-step method known per se, often using mechanical means, for example those described in EP-A 355 000. Details of processing means also suitable in accordance with the invention are reported in Kunststoff-Handbuch, volume VII, edited by Vieweg and Höchtlen, Carl-Hanser-Verlag, Munich 1993, for example on pages 139 to 265.

The viscoelastic flexible polyurethane foams may be produced as molded foams or else as slabstock foams, preferably as slabstock foams. The invention therefore provides a process for producing the viscoelastic flexible polyurethane foams, the viscoelastic flexible polyurethane foams produced by these processes, the viscoelastic flexible slabstock polyurethane foams/flexible molded polyurethane foams produced by these processes, the use of the flexible polyurethane foams for production of moldings, and the moldings themselves. The viscoelastic flexible polyurethane foams obtainable according to the invention find application for example in: furniture cushioning, textile inserts, mattresses, automotive seats, headrests, armrests, sponges and component elements.

The characteristic value (index) indicates the percentage ratio of the actually employed isocyanate amount to the stoichiometric, i.e. calculated for the conversion of the OH equivalents, amount of isocyanate groups (NCO) amount.

Characteristic value=[(isocyanate amount employed):(isocyanate amount calculated)]·100 (II)

The viscoelastic polyurethane foams produced by the process according to the invention are produced at an isocyanate index of 70 to 120, preferably of 80 to 100.

The viscoelastic polyurethane foams produced in accordance with the invention have tensile strengths of ≧90 kPa, preferably ≧95 kPa, particularly preferably ≧100 kPa.

The process according to the invention is preferably employed for producing viscoelastic flexible slabstock polyurethane foam. The viscoelastic polyurethane foams obtainable by the process according to the invention find application for example in furniture cushioning, textile inserts, mattresses, automotive seats, headrests, armrests, sponges and component elements and also seat and dashboard trim, preferably in furniture cushioning, textile inserts, mattresses, automotive seats and headrests.

In a first embodiment of the process for producing viscoelastic polyurethane foam, said foam is obtainable by reaction of a polyol component A comprising
A1 at least one polyether polyol having a functionality of 2 to 6, having an OH number according to DIN 53240 of ≧20 to ≦80 mg KOH/g, wherein the ethylene oxide is present as an EO mixed block and a terminal block of pure ethylene oxide, wherein the total content of ethylene oxide is ≧50 wt %, with a content of primary hydroxyl groups of ≧50 mol %,
A2 at least one polyether polyol having a functionality of 2 to 6, having an OH number according to DIN 53240 of ≧180 to ≦320 mg KOH/g, wherein the ethylene oxide is present as an EO mixed block, wherein the total content of ethylene oxide is 0 to 10 wt %,
A3 at least one polyether polyol having a functionality of 2 to 6, having an OH number according to DIN 53240 of ≧15 to ≦40 mg KOH/g, wherein the ethylene oxide is present as a terminal block of pure ethylene oxide and optionally as an EO mixed block, wherein the total content of ethylene oxide is 5 to 30 wt %, with a content of primary hydroxyl groups of ≧50 mol %,
A4 at least one polyether polyol having a functionality of ≧2.0 to ≦2.2, having an OH number according to DIN 53240 of ≧10 to ≦40 mg KOH/g, wherein the ethylene oxide is present as a terminal block of pure ethylene oxide and optionally as an EO mixed block, wherein the total content of ethylene oxide is 5 to 30 wt %, with a content of primary hydroxyl groups of ≧50 mol %,
A5 water and/or physical blowing agent,
A6 compounds comprising polyether polyols having an OH number according to DIN 53420 of 250 to 550 mg KOH/g.
A7 auxiliary and added substances such as
   a) catalysts,
   b) surface-active added substances,
   c) additives

with component B comprising di- and/or polyisocyanates

at an isocyanate index of 70 to 120.

In a second embodiment of the process according to the first embodiment, the components are reacted according to the following proportions, wherein the weight fractions of A1, A2, A3 and A4 sum to 100: A1: from 25 to 45 parts by wt; A2: from 23 to 40 parts by wt, A3: from 20 to 35 parts by wt, A4: from 0 to 10 parts by wt, A5: 0.5 to 25 parts by wt (based on the sum of the parts by wt of components A1, A2, A3 and A4), A6: from 0.1 to 10.0 parts by wt (based on the sum of the parts by wt of components A1, A2, A3 and A4), A7: 0.05 to 10.0 parts by wt (based on the sum of the parts by wt of components A1, A2, A3 and A4),

In a third embodiment of the process according to the first embodiment, the components are reacted according to the following proportions, wherein the weight fractions of A1, A2, A3 and A4 sum to 100: A1: from 28 to 40 parts by wt; A2: from 25 to 38 parts by wt, A3: from 23 to 33 parts by wt, A4: from 0 to 8 parts by wt, A5: 0.8 to 15 parts by wt (based on the sum of the parts by wt of components A1, A2, A3 and A4), A6: from 0.2 to 9.0 parts by wt (based on the sum of the parts by wt of components A1, A2, A3 and A4), A7: 0.1 to 7.5 parts by wt (based on the sum of the parts by wt of components A1, A2, A3 and A4),

In a fourth embodiment of the process according to the first to third embodiments, the polyol component A comprises
A1 at least one polyether polyol having a functionality of 2 to 4, having an OH number according to DIN 53240 of ≧25 to ≦50 mg KOH/g, wherein the ethylene oxide is present as an EO mixed block and a terminal block of pure ethylene oxide, wherein the total content of ethylene oxide is ≧60 wt %, with a content of primary hydroxyl groups of ≧60 mol %,
A2 at least one polyether polyol having a functionality of 2 to 4, having an OH number according to DIN 53240 of ≧190 to ≦300 mg KOH/g, wherein the ethylene oxide is present as an EO mixed block, wherein the total content of ethylene oxide is 0 to 5 wt %,
A3 at least one polyether polyol having a functionality of 2 to 4, having an OH number according to DIN 53240 of ≧20 to ≦35 mg KOH/g, wherein the ethylene oxide is present as a terminal block of pure ethylene oxide and optionally as an EO mixed block, wherein the total content of ethylene oxide is 10 to 25 wt %, with a content of primary hydroxyl groups of ≧60 mol %,
A4 at least one polyether polyol having a functionality of ≧2.0 to ≦2.2, having an OH number according to DIN 53240 of ≧15 to ≦35 mg KOH/g, wherein the ethylene oxide is present as a terminal block of pure ethylene oxide and optionally as an EO mixed block, wherein the total content of ethylene oxide is 10 to 25 wt %, with a content of primary hydroxyl groups of ≧60 mol %,
A5 water and/or physical blowing agent,
A6 compounds comprising polyether polyols having an OH number according to DIN 53420 of 300 to 500 mg KOH/g.
A7 auxiliary and added substances such as
   a) catalysts,
   b) surface-active added substances,
   c) additives.

In a fifth embodiment of the process according to the first to fourth embodiments, at least one compound selected from the group consisting of 2,4- and/or 2,6-tolylene diisocyanate, 4,4′-, 2,4′-, 2,2′-diphenylmethane diisocyanate, oligomeric diphenylmethane diisocyanate and polyphenylpolymethylene polyisocyanate (“polynuclear MDI”) is employed as component B.

In a sixth embodiment of the process according to the first to fifth embodiments, component B comprises a mixture of 4,4′-, 2,4′-, 2,2′-diphenylmethane diisocyanate, oligomeric diphenylmethane diisocyanate and/or polyphenylpolymethylene polyisocyanate (“polynuclear MDI”).

In a seventh embodiment of the process according to the first to sixth embodiments, component B has an NCO content of 20 to 45 wt %.

In an eighth embodiment of the process according to the first to seventh embodiments, component B has an NCO content of 30.5 to 34 wt %. In a ninth embodiment of the process according to the first to eighth embodiments, production of the viscoelastic polyurethane foam is effected at an isocyanate index of 80-100.

In a tenth embodiment of the process according to the first to ninth embodiments, the polyol component A comprises
A1 at least one polyether polyol having a functionality of 2 to 4, having an OH number according to DIN 53240 of ≧30 to ≦40 mg KOH/g, wherein the ethylene oxide is present as an EO mixed block and a terminal block of pure ethylene oxide, wherein the total content of ethylene oxide is ≧65 wt %, with a content of primary hydroxyl groups of ≧75 mol %,
A2 at least one polyether polyol having a functionality of 2 to 4, having an OH number according to DIN 53240 of ≧210 to ≦280 mg KOH/g, wherein the ethylene oxide is present as an EO mixed block, wherein the total content of ethylene oxide is 0 wt %,
A3 at least one polyether polyol having a functionality of 2 to 4, having an OH number according to DIN 53240 of ≧23 to ≦33 mg KOH/g, wherein the ethylene oxide is present as a terminal block of pure ethylene oxide and optionally as an EO mixed block, wherein the total content of ethylene oxide is 10 to 20 wt %, with a content of primary hydroxyl groups of ≧70 mol %,
A4 at least one polyether polyol having a functionality of ≧2.0 to ≦2.2, having an OH number according to DIN 53240 of ≧20 to ≦30 mg KOH/g, wherein the ethylene oxide is present as a terminal block of pure ethylene oxide and optionally as an EO mixed block, wherein the total content of ethylene oxide is 10 to 20 wt %, with a content of primary hydroxyl groups of ≧70 mol %,
A5 water and/or physical blowing agent,
A6 compounds comprising polyether polyols having an OH number according to DIN 53420 of 350 to 400 mg KOH/g.
A7 auxiliary and added substances such as
   a) catalysts,
   b) surface-active added substances,
   c) additives.

In an eleventh embodiment of the process according to the first to tenth embodiments, the components are reacted according to the following proportions, wherein the weight fractions of A1, A2, A3 and A4 sum to 100: A1: from 32 to 38 parts by wt; A2: from 28 to 34 parts by wt, A3: from 27 to 31 parts by wt, A4: from 0 to 6 parts by wt, A5: 1.0 to 5.0 parts by wt (based on the sum of the parts by wt of components A1, A2, A3 and A4), A6: from 3.0 to 7.0 parts by wt (based on the sum of the parts by wt of components A1, A2, A3 and A4), A7: 0.15 to 7.0 parts by wt (based on the sum of the parts by wt of components A1, A2, A3 and A4),

In a twelfth embodiment of the process according to the first to eleventh embodiments, component B has an NCO content of 28 to 40 wt %.

In a thirteenth embodiment, the viscoelastic polyurethane foams are obtainable by the process according to the first to twelfth embodiments.

In a fourteenth embodiment of the viscoelastic polyurethane foam according to the thirteenth embodiment, these viscoelastic polyurethane foams have a tensile strength of ≧95 kPa.

In a fifteenth embodiment of the viscoelastic polyurethane foam according to the thirteenth or fourteenth embodiment, said foams are used for producing furniture cushioning, textile inserts, mattresses, automotive seats, headrests, armrests, sponges, foam sheetings for use in automotive parts such as headliners, door trims, seat covers and component elements for example.

In a sixteenth embodiment of the invention, a polyol composition comprising
A1 at least one polyether polyol having a functionality of 2 to 6, having an OH number according to DIN 53240 of ≧20 to ≦80 mg KOH/g, wherein the ethylene oxide is present as an EO mixed block and a terminal block of pure ethylene oxide, wherein the total content of ethylene oxide is ≧50 wt %, with a content of primary hydroxyl groups of ≧50 mol %,
A2 at least one polyether polyol having a functionality of 2 to 6, having an OH number according to DIN 53240 of ≧180 to ≦320 mg KOH/g, wherein the ethylene oxide is present as an EO mixed block, wherein the total content of ethylene oxide is 0 to 10 wt %,
A3 at least one polyether polyol having a functionality of 2 to 6, having an OH number according to DIN 53240 of ≧15 to ≦40 mg KOH/g, wherein the ethylene oxide is present as a terminal block of pure ethylene oxide and optionally as an EO mixed block, wherein the total content of ethylene oxide is 5 to 30 wt %, with a content of primary hydroxyl groups of ≧50 mol %,
A4 at least one polyether polyol having a functionality of ≧2.0 to ≦2.2, having an OH number according to DIN 53240 of ≧10 to ≦40 mg KOH/g, wherein the ethylene oxide is present as a terminal block of pure ethylene oxide and optionally as an EO mixed block, wherein the total content of ethylene oxide is 5 to 30 wt %, with a content of primary hydroxyl groups of ≧50 mol %,
is claimed.

In a seventeenth embodiment of the invention, the polyol composition according to the sixteenth embodiment comprises the polyether polyols A1 to A4 in the following amounts: from 25 to 45 wt % A1, from 23 to 40 wt % A2, from 20 to 35 wt % A3, from 0 to 10 wt % A4.

In an eighteenth embodiment of the invention, the polyol composition according to the sixteenth embodiment comprises the polyether polyols A1 to A4 in the following amounts: A1: from 28 to 40 parts by wt; A2: from 25 to 38 parts by wt, A3: from 23 to 33 parts by wt, A4: from 0 to 8 parts by wt.

In a nineteenth embodiment, the polyol composition according to the sixteenth to eighteenth embodiments comprises
A1 at least one polyether polyol having a functionality of 2 to 4, having an OH number according to DIN 53240 of ≧25 to ≦50 mg KOH/g, wherein the ethylene oxide is present as an EO mixed block and a terminal block of pure ethylene oxide, wherein the total content of ethylene oxide is ≧60 wt %, with a content of primary hydroxyl groups of ≧60 mol %,
A2 at least one polyether polyol having a functionality of 2 to 4, having an OH number according to DIN 53240 of ≧190 to ≦300 mg KOH/g, wherein the ethylene oxide is present as an EO mixed block, wherein the total content of ethylene oxide is 0 to 5 wt %,
A3 at least one polyether polyol having a functionality of 2 to 4, having an OH number according to DIN 53240 of ≧20 to ≦35 mg KOH/g, wherein the ethylene oxide is present as a terminal block of pure ethylene oxide and optionally as an EO mixed block, wherein the total content of ethylene oxide is 10 to 25 wt %, with a content of primary hydroxyl groups of ≧60 mol %,
A4 at least one polyether polyol having a functionality of ≧2.0 to ≦2.2, having an OH number according to DIN 53240 of ≧15 to ≦35 mg KOH/g, wherein the ethylene oxide is present as a terminal block of pure ethylene oxide and optionally as an EO mixed block, wherein the total content of ethylene oxide is 10 to 25 wt %, with a content of primary hydroxyl groups of ≧60 mol %.

In a twentieth embodiment, the polyol composition according to the sixteenth to nineteenth embodiments comprises
A1 at least one polyether polyol having a functionality of 2 to 4, having an OH number according to DIN 53240 of ≧30 to ≦40 mg KOH/g, wherein the ethylene oxide is present as an EO mixed block and a terminal block of pure ethylene oxide, wherein the total content of ethylene oxide is ≧65 wt %, with a content of primary hydroxyl groups of ≧75 mol %,
A2 at least one polyether polyol having a functionality of 2 to 4, having an OH number according to DIN 53240 of ≧210 to ≦280 mg KOH/g, wherein the ethylene oxide is present as an EO mixed block, wherein the total content of ethylene oxide is 0 wt %,
A3 at least one polyether polyol having a functionality of 2 to 4, having an OH number according to DIN 53240 of ≧23 to ≦33 mg KOH/g, wherein the ethylene oxide is present as a terminal block of pure ethylene oxide and optionally as an EO mixed block, wherein the total content of ethylene oxide is 10 to 20 wt %, with a content of primary hydroxyl groups of ≧70 mol %,
A4 at least one polyether polyol having a functionality of ≧2.0 to ≦2.2, having an OH number according to DIN 53240 of ≧20 to ≦30 mg KOH/g, wherein the ethylene oxide is present as a terminal block of pure ethylene oxide and optionally as an EO mixed block, wherein the total content of ethylene oxide is 10 to 20 wt %, with a content of primary hydroxyl groups of ≧70 mol %.

In a twenty-first embodiment, the polyol composition according to the sixteenth to twentieth embodiments comprises the polyether polyols A1 to A4 in the following amounts: A1: from 32 to 38 parts by wt; A2: from 28 to 34 parts by wt, A3: from 27 to 31 parts by wt, A4: from 0 to 6 parts by wt.

### EXAMPLES

Polyol A1-1 Polyether polyol having a functionality of 3, an OH number according to DIN 53240 of 37 mg KOH/g, an EO mixed block and a terminal block of pure ethylene oxide with a total content of ethylene oxide of 72 wt % and a primary hydroxyl group content of 83 mol %.
Polyol A2-1 Polyether polyol having a functionality of 3, an OH number according to DIN 53240 of 235 mg KOH/g, wherein the polyether polyol is a pure polypropylene polyol.
Polyol A3-1 Polyether polyol having a functionality of 3, an OH number according to DIN 53240 of 28 mg KOH/g, a terminal block of pure ethylene oxide with a total content of ethylene oxide of 15 wt % and a primary hydroxyl group content of 85 mol %.
Polyol A4-1 Polyether polyol having a functionality of 2, an OH number according to DIN 53240 of 28 mg KOH/g, a terminal block of pure ethylene oxide with a total content of ethylene oxide of 13.2 wt % and a primary hydroxyl group content of 86.8 mol %.
A6 Added substance VP.PU 49WB81 from Covestro Deutschland AG; additive for improving viscoelastic properties
A7-1 Silicone stabilizer Tegostab® B 8681 from Evonik
A7-2 Dabco® NE 500 from Air Products
A7-3 Dabco® NE 300 from Air Products
A7-4 Urea, technical grade, ≧98% purity

Isocyanate component B:

Mixture of diphenylmethane diisocyanate isomers (MDI) and higher-functional homologs having an NCO content of 30.5 to 34.0 wt %.

The characteristic value (index) indicates the ratio of the actually employed isocyanate amount to the stoichiometric, i.e. calculated for the conversion of the OH equivalents, amount of isocyanate groups (NCO) amount:

Characteristic value=[(isocyanate amount employed):(isocyanate amount calculated)]·100 (II)

Apparent density was determined according to DIN EN ISO 845.

OH number was determined according to DIN 53240.

Tensile strength and elongation at break were determined according to DIN EN ISO 1798.

Compression hardness (CLD 40%, 4th compression) was determined according to DIN EN ISO 3386-1 at 40% deformation, 4th cycle.

Compression set (“CS”) at 50% (CS 50%) and 90% (CS 90%) compression over 22 hours at 70° C. is determined according to DIN EN ISO 1856 and is reported in %.

Determination of ball rebound resilience according to DIN EN ISO 8307.

NCO content was determined based on DIN EN ISO 14896.

Analytical determination of the primary OH groups was effected by integral evaluation of 1H NMR spectra of the respective products.

The viscoelastic polyurethane foam was produced as follows:

The input materials recited in the examples of in table 1 which follows were reacted with one another in the manner of processing customary for the production of polyurethane foams by the one-step method.

TABLE 1
Viscoelastic polyurethane foams

| | | 1 | 2 | 3 | 4 |
|---|---|---|---|---|---|
| A1-1 | [parts by wt] | 35.00 | 35.00 | 36.58 | 36.58 |
| A2-1 | [parts by wt] | 31.42 | 31.42 | 32.84 | 32.84 |
| A3-1 | [parts by wt] | 29.25 | 29.25 | 30.58 | 30.58 |
| A4-1 | [parts by wt] | 4.33 | 4.33 | 0 | 0 |
| A5 water (total) | [parts by wt] | 1.97 | 1.97 | 1.97 | 1.97 |
| A6 | [parts by wt] | 8.00 | 5.00 | 8.00 | 5.00 |
| A7-1 | [parts by wt] | 0.20 | 0.20 | 0.20 | 0.20 |
| A7-2 | [parts by wt] | 0.76 | 0.76 | 0.76 | 0.76 |
| A7-3 | [parts by wt] | 0.18 | 0.18 | 0.18 | 0.18 |
| A7-4 * | [parts by wt] | 0.45 | 0.45 | 0.45 | 0.45 |
| Component B | [parts by wt] | 54.8 | 53.0 | 54.62 | 51.98 |
| Index | [—] | 93 | 93 | 93 | 93 |
| Apparent density | [kg/m³] | 54.8 | 47.28 | 53.8 | 52.7 |
| CLD 40% | [kPa] | 2.34 | 2.05 | 2.91 | 2.28 |
| (4th compression) | | | | | |
| Tensile strength | [kPa] | 108 | 112 | 118 | 115 |
| Elongation at break | [%] | 140 | 141 | 133 | 144 |
| Ball rebound resilience | [%] | 3 | 6 | 7 | 7 |
| CS 50% | [%] | 1.6 | 1.2 | 1.4 | 1.4 |
| CS 90% | [%] | 1.8 | 1.7 | 1.3 | 2.1 |

* Employed as 50% aqueous solution, reported as pure urea amount

1. A process for producing viscoelastic polyurethane foam obtainable by reaction of a polyol component A comprising.
A1 at least one polyether polyol having a functionality of 2 to 6, having an OH number according to DIN 53240 of ≧20 to ≦5. 80 mg KOH/g, wherein the ethylene oxide is present as an EO mixed block and a terminal block of pure ethylene oxide, wherein the total content of ethylene oxide is ≧50 wt %, with a content of primary hydroxyl groups of ≧50 mol %,
A2 at least one polyether polyol having a functionality of 2 to 6, having an OH number according to DIN 53240 of ≧180 to ≦5 320 mg KOH/g, wherein the ethylene oxide is present as an EO mixed block, wherein the total content of ethylene oxide is 0 to 10 wt %,
A3 at least one polyether polyol having a functionality of 2 to 6, having an OH number according to DIN 53240 of ≧15 to ≦40 mg KOH/g, wherein the ethylene oxide is present as a terminal block of pure ethylene oxide and optionally as an EO mixed block, wherein the total content of ethylene oxide is 5 to 30 wt %, with a content of primary hydroxyl groups of ≧50 mol %,
A4 at least one polyether polyol having a functionality of ≧2.0 to ≦2.2, having an OH number according to DIN 53240 of ≧10 to ≦5 40 mg KOH/g, wherein the ethylene oxide is present as a terminal block of pure ethylene oxide and optionally as an EO mixed block, wherein the total content of ethylene oxide is 5 to 30 wt %, with a content of primary hydroxyl groups off ≧50 mol %,
A5 water and/or physical blowing agent,
A6 compounds comprising polyether polyols having an OH number according to DIN 53420 of 250 to 550 mg KOH/g,
and
A7 auxiliary and added substances comprising
a) catalysts,
b) surface-active added substances,
c) additives
with
component B comprising di- and/or polyisocyanates
at an isocyanate index of 70 to 120, with the proviso that the polyether polyols A3 and A4 are different polyether polyols, and the polyether polyols A2 and A6 are different polyether polyols.

2. The process as claimed in claim 1, wherein the components are reacted according to the following proportions and wherein the weight fractions of A1, A2, A3 and A4 sum to 100: A1: from 25 to 45 parts by wt, A2: from 23 to 40 parts by wt, A3: from 20 to 35 parts by wt, A4: from 0 to 10 parts by wt; A5: 0.5 to 25 parts by wt, based on the sum of the parts by wt of components A1 A2, A3 and A4, A6: from 0.1 to 10.0 parts by wt, based on the sum of the parts by wt of components A1, A2, A3 and A4, A7: 0.05 to 10.0 parts by wt, based on the sum of the parts by wt of components A1 , A2, A3 and A4.

3. The process as claimed in claim 1, wherein the components are reacted according to the following proportions and wherein the weight fractions of A1, A2, A3 and A4 sum to 100: A1: from 28 to 40 parts by wt, A2: from 25 to 38 parts by wt, A3: from 23 to 33 parts by wt, A4: from 0 to 8 parts by wt; A5: 0.8 to 15 parts by wt, based on the sum of the parts by wt of components A1, A2, A3 and A4, A6: from 0.2 to 9.0 parts by wt, based on the sum of the parts by wt of components A1 A2, A3 and A4, A7: 0.1 to 7.5 parts by wt, based on the sum of the parts by wt of components A1, A2, A3 and A4.

4. The process as claimed in claim 1, wherein the polyol component A comprises
A1 at, least one polyether polyol having a functionality of 2 to 4, having an OH number according to DIN 53240 of ≧25 to ≦50 mg KOH/g, wherein the ethylene oxide is present as an EO mixed block and a terminal block of pure ethylene oxide, wherein the total content of ethylene oxide is 60 wt %, with a content of primary hydroxyl groups of ≧60 mol %,
A2 at least one polyether polyol having a functionality of 2 to 4, having an OH number according to DIN 53240 of ≧190 to ≦300 mg KOH/g, wherein the ethylene oxide is present as an EO mixed block, wherein the total content of ethylene oxide is 0 to 5 wt %,
A3 at least one polyether polyol having a functionality of 2 to 4, having an OH number according to DIN 53240 of ≧20 to ≦35 mg KOH/g, wherein the ethylene oxide is present as a terminal block of pure ethylene oxide and optionally as an EO mixed block, wherein the total content of ethylene oxide is 10 to 25 wt %, with a content of primary hydroxyl groups of 60 mol %,
A4 at least one polyether polyol having a functionality of ≧2.0 to ≦2.2, having an OH number according to DIN 53240 of ≧15 to ≦35 mg KOH/g, wherein the ethylene oxide is present as a terminal block of pure ethylene oxide and optionally as an EO mixed block, wherein the total content of ethylene oxide is 10 to 25 wt %, with a content of primary hydroxyl groups of 60 mol %,
A5 water and/or physical blowing agent,
A6 compounds comprising polyether polyols having an OH number according to DIN 53420 of 300 to 500 mg KOH/g,
and
A7 auxiliary and added substance s comprising such as
a) catalysts,
b) surface-active added substances,
c) additives,
with the proviso that the polyether polyols A3 and A4 are different polyether polyols, and the polyether polyols A2 and A6 are different polyether polyols.

5. The process as claimed in claim 1, wherein component B comprises at least one compound selected from the group consisting of 2,4- and/or 2,6-tolylene diisocyanate, 4,4′-, 2,4′-, 2,2′-diphenylmethane thisocyanate, oligomeric diphenylmethane diisocyanate and polyphenylpolymethylene polyisocyanate (“polynuclear MDI”).

6. The process as claimed in claim 1, wherein component B comprises a mixture of 4,4′-, 2,4′-, 2,2′-diphenylmethane diisocyanate, oligomeric diphenylmethane diisocyanate and/or polyphenyl polymethylene polyisocyanate (“polycyclic MDI”).

7. The process as claimed in claim 1, wherein component B has an NCO content of 20 to 45 wt %.

8. The process as claimed in claim 1, wherein component B has an NCO content of 30.5 to 34 wt %.

9. The process as claimed in claim 1, wherein production of the viscoelastic polyurethane foam is effected at an isocyanate index of 80-100.

10. A viscoelastic polyurethane foam obtainable by the process as claimed in claim 1.

11. The viscoelastic polyurethane foam according to claim 10, wherein the viscoelastic polyurethane foam has a tensile strength of 95 kPa.

12. An article of bedding comprising the viscoelastic polyurethane foam as claimed in claim 10.

13. A polyol composition comprising
A1 at least one polyether polyol having a functionality of 2 to 6, having an OH number according to DIN 53240 of ≧20 to ≦80 mg KOH/g, wherein the ethylene oxide is present as an EO mixed block and a terminal block of pure ethylene oxide, wherein the total content of ethylene oxide is 50 wt %, with a content of primary hydroxyl groups of 50 mol %,
A2 at least one polyether polyol having a functionality of 2 to 6, having an OH number according to DIN 53240 of ≧180 to ≦320 mg KOH/g, wherein the ethylene oxide is present as an EO mixed block, wherein the total content of ethylene oxide is 0 to 10 wt %,
A3 at least one polyether polyol having a functionality of 2 to 6, having an OH number according to DIN 53240 of ≧15 to ≦40 mg KOH/g, wherein the ethylene oxide is present as a terminal block of pure ethylene oxide and optionally as an EO mixed block, wherein the total content of ethylene oxide is 5 to 30 wt %, with a content of primary hydroxyl groups of ≧50 mol %,
and
A4 at least one polyether polyol having a functionality of ≧2.0 to ≦2.2, having an OH number according to DIN 53240 of ≧10 to ≦40 mg KOH/g, wherein the ethylene oxide is present as a terminal block of pure ethylene oxide and optionally as an EO mixed block, wherein the total content of ethylene oxide is 5 to 30 wt %, with a content of primary hydroxyl groups of 50 mol %,
with the proviso that polyether polyols A3 and A4 are different polyether polyols.

14. The polyol composition as claimed in claim 13, wherein the polyether polyols A1 to A4 are present in the following amounts: from 25 to 45 wt % A1, from 23 to 40 wt % A2, from 20 to 35 wt % A3, and from 0 to 10 wt % A4.

15. The polyol composition as claimed in claim 13, wherein the polyether polyols A1 to A4 are present in the following amounts: A1: from 28 to 40 parts by wt; A2: from 25 to 38 parts by wt, A3: from 23 to 33 parts by wt, and A4: from 0 to 8 parts by wt.

16. An automotive part comprising the viscoelastic polyurethane foam as claimed in claim 10.

17. A furniture cushion comprising the viscoelastic polyurethane foam as claimed in claim 10.
